(19) United States
(12) Patent Application Publication
(10) Pub. No.: US 2025/0097084 A1
(43) Pub. Date: Mar. 20, 2025

(54) SIGNAL EQUALIZATION OPTIMIZATION TECHNIQUES

(71) Applicants: Leo Chen Ling, Beaverton, OR (US); Cobalt Martin, Hillsboro, OR (US); Oluwafemi Akinwale, Hayward, CA (US); Kusumakumari Matta, Fremont, CA (US); Francisco Javier Galarza Medina, Hillsboro, OR (US)

(72) Inventors: Leo Chen Ling, Beaverton, OR (US); Cobalt Martin, Hillsboro, OR (US); Oluwafemi Akinwale, Hayward, CA (US); Kusumakumari Matta, Fremont, CA (US); Francisco Javier Galarza Medina, Hillsboro, OR (US)

(21) Appl. No.: 18/369,336

(22) Filed: Sep. 18, 2023

(51) Int. Cl. H04L 27/01; H04B 17/309; H04L 25/03

(52) U.S. Cl. CPC H04L 27/01; H04B 17/309; H04L 25/03885

(57) ABSTRACT

A system includes a first Tx circuit, a first Rx circuit, a redriver circuit, and an equalization circuit. The redriver circuit includes a second Rx circuit and a second Tx circuit. The second Rx circuit is coupled to the first Tx circuit, and the second Tx circuit is coupled to the first Rx circuit. The equalization circuit includes at least one processor to generate a sample search space with a plurality of samples. The sample search space is based on a plurality of Rx equalization parameters and a plurality of Tx equalization parameters. The at least one processor is further to partition the sample search space into a set of successively smaller partitions. A set of equalization parameters for the first Tx circuit, the first Rx circuit, the second Tx circuit, and the second Rx circuit is generated based on the set of successively smaller partitions.

### BACKGROUND

Interconnect physical layer (PHY) devices require sophisticated signal equalization (EQ). Suboptimal EQ implementations do not take full advantage of silicon capabilities and may require expensive design tradeoffs such as printed circuit board (PCB) stack-up improvements. However, finding optimized EQ presets and recipes requires significant development time.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings in which:

FIG. 1 illustrates the initial partitioning of a search space configured based on a receive (Rx) equalization parameter of continuous time linear equalization (CTLE) and a transmit (Tx) equalization parameter of a Tx main tap, in accordance with some embodiments.

FIG. 2 illustrates the splitting of a search space from a previously optimal result, in accordance with some embodiments.

FIG. 3 illustrates successive partitions of the search space until a global minimum is found, in accordance with some embodiments.

FIG. 4 is a block diagram of a communication system using an equalization processor to perform equalization based on the disclosed techniques, in accordance with some embodiments.

FIG. 5 is a combination graph showing a comparison between equalization tuning using the disclosed techniques and equalization tuning based on coarse transmitted taps sweeps on a 28 dB (insertion loss (IL) at 13.28 GHz) channel at 53 GBit/s data communication, in accordance with some embodiments.

FIG. 6 is a combination graph of a comparison between using a recommended preset versus using the disclosed equalization techniques for each channel, in accordance with some embodiments.

FIG. 7 is a block diagram of a communication system using an equalization processor and a redriver to perform equalization based on the disclosed techniques, in accordance with some embodiments.

FIG. 8 is a graph of bit error rate (BER)-based equalization using the disclosed techniques during tuning of 30 dB (IL at 13.28 GHZ) channel with a redriver, in accordance with some embodiments.

FIG. 9 is a flow diagram of an example method for signal equalization, in accordance with some embodiments; and

FIG. 10 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

As used herein, the term “chip” (or die) refers to a piece of a material, such as a semiconductor material, that includes a circuit such as an integrated circuit or a part of an integrated circuit. The term “memory IP” indicates memory intellectual property. The terms “memory IP,” “memory device,” “memory chip,” and “memory” are interchangeable.

Industry specs define a set of generic EQ presets and an EQ tuning framework for interoperability, but the specific implementation is often left to the user. To generate a preset for a given channel, a sweep is usually conducted over all the different EQ settings of the PHY. For fine-tuning beyond presets, specs may define a generic optimization algorithm or none at all. However, existing EQ techniques can be associated with certain disadvantages. For example, conducting a full search of the equalization parameters is time-consuming and impractical during actual link training. Given the challenges of finding proper EQ settings, some implementations may only hard code a small set of recipe schemes in firmware to reduce complexity.

To efficiently discover the optimal set of equalization parameters for a given channel, the disclosed EQ techniques can be applied to determine EQ parameters for multiple devices or circuitry in a communication system. The disclosed techniques can be applied with existing equalization hardware and can be integrated within the link training process. By working independently of channel typology and the underlying waveform, the disclosed EQ techniques can tune multiple transmitters and receivers to the user's EQ metric of choice (e.g., bit error rate (BER), signal-to-noise ratio (SNR), etc.).

The disclosed EQ techniques support tuning equalization parameters across a variety of channel topologies increasing the robustness of PHY devices at higher data rates. The disclosed EQ techniques can be applied in tandem with existing equalization designs and metrics allowing the disclosed techniques to be adapted into link training with minimal architectural changes. During experiments, the disclosed EQ techniques converged to an optimal EQ parameter in much fewer metric evaluations compared to brute force methods associated with existing EQ techniques (in one case reducing the number of evaluations by at least three orders of magnitude).

Interconnect PHY devices require complex, well-optimized signal EQ to support high-speed interfaces. While many of these EQ features are already available within the silicon, finding optimized EQ presets or recipes require significant development time which delays the time to market. The disclosed EQ techniques can be used to remove the need for more expensive designs (e.g., PCB stack-up changes, redriver, and retimer designs), reduce noise susceptibility of the channel, accelerate link training with properly chosen presets, and allows customers to leverage the full performance of silicon designs.

Finding the optimal set of EQ parameters for a given channel can prove challenging since Tx, Rx, and any redrivers (or retimers) within the channel have their own set of tunable parameters which rapidly expands the possible search space of EQ parameters. Further compounding the previous issue, the evaluation of channel metrics such as BER or SNR is time-consuming. Simply sweeping over all possible combinations is time-consuming. In the lab, these metrics are additionally subjected to measurement noise and other non-idealities. Lastly, direct measurement of the waveform is impossible or simply impractical for some points within the channel. This limits the usable data we can collect. In some cases, such as with redrivers, it is very difficult to optimize each Tx-to-Rx pair separately.

When optimizing EQ there are limitations on the measurable gradient (rate of change) due to measurement noise, the discrete steps of the EQ parameters, and, in some cases, the metric itself. For instance, the metric of BER has an upper bound of 50%. Often, large swaths of the EQ search space will be completely unviable and report a measured BER of around 50%. At these points, the magnitude of the gradient is small compared to the measured noise. If an initial point is chosen within this plateau, the measured gradient might not point toward the global minimum. Furthermore, outside of simulations, measuring the gradient is not trivial. Especially due to the time-consuming nature of channel metric evaluations. These difficulties highlight the benefits of selecting a derivative-free optimization algorithm in connection with the disclosed techniques.

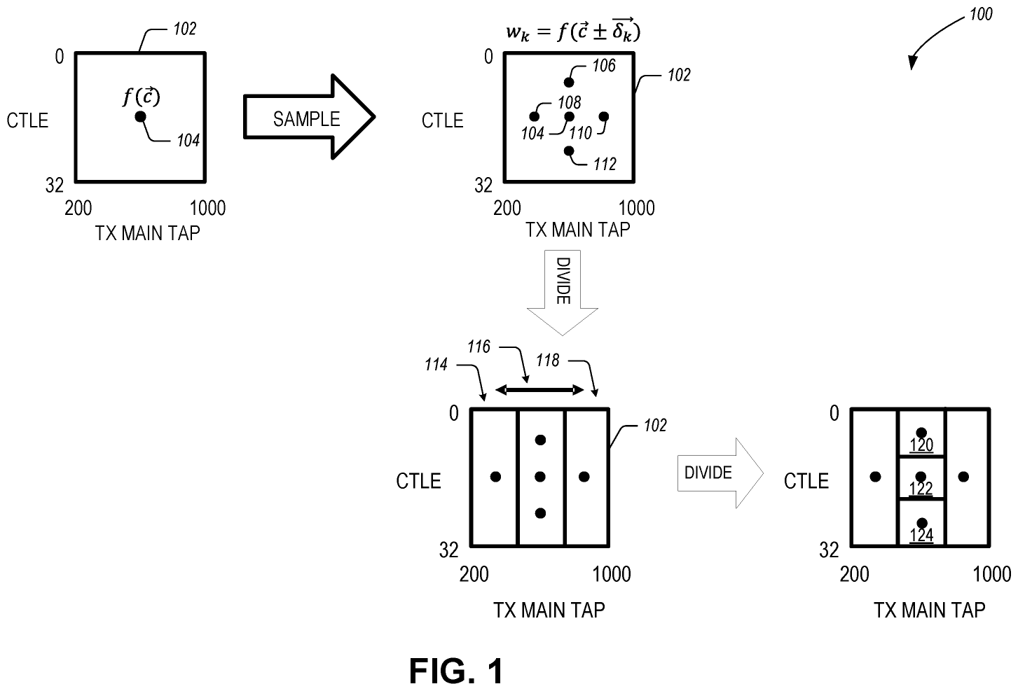

For tested topologies, the EQ parameters can have a relatively small number of tunable variables, making them suitable for using the DIRECT global optimization algorithm, which has not been adapted and used in signal integrity applications. The disclosed EQ techniques can include branch-and-bound techniques based on the DIRECT algorithm. More specifically, the disclosed techniques can be based on partitioning a search space into successively smaller subsets. The disclosed graphs confirm the efficiency that applies to EQ optimization. For instance, the disclosed EQ techniques can be applied on CTLE and Tx main taps, as shown in connection with FIGS. 1-3 below.

FIG. 1 illustrates a diagram 100 of the initial partitioning of a search space configured based on a Rx equalization parameter of CTLE and a Tx equalization parameter of a Tx main tap, in accordance with some embodiments.

FIG. 1 shows how a search space is initially divided. For example, search space 102 can be a two-dimensional (2D) search space based on an Rx equalization parameter (e.g., CTLE) and a Tx equalization parameter (e.g., Tx main tap).

The metric of choice for purposes of final EQ parameter selection for signal EQ can be flexible and can be interchanged as needed. For example, the disclosed EQ techniques can be applied to various signal quality criteria based on a specification, such as BER, eye height/width, receiver margins, etc. It can also include metrics such as frame loss ratio (FLR) after forward error correction (FEC).

In some aspects, signal EQ can include a tunable value/input which can be tuned using the disclosed techniques. The disclosed signal EQ techniques are not restricted to electrical connections and can include optical or radio/cellular links with some “metric” that can be optimized. Example equalization parameters that can be used for configuring a search space in connection with the disclosed techniques include one or more of the following:
(a) Feed-forward equalization (FFE) and decision feedback equalization (DFE) which have adjustable “taps” that affect magnitude.
(b) Continuous linear time equalizer (CTLE) which usually has an adjustable gain at low and/or high frequencies. FFE, DFE, and CTLE can be considered EQ parameters for the equalization of serial links.
(c) Analog front-end (AFE) attenuation, which lowers input signal before post-processing by an adjustable level.
(d) Variable gain amplifier (VGA), which generates adjustable gain across a wide bandwidth.
(e) Swing which indicates the range of output voltages.
(f) Eye levels which indicate voltage and/or optical power levels of the output levels (in case one symbol represents multiple bits). While usually set equidistant from each other, using custom levels may help compensate for nonlinearities.

In some aspects, the EQ parameters can include tunable parameters associated with optical devices (e.g., parameters to control semiconductor optical amplifiers, adjustable optical attenuators, etc.). Other tunable parameters exist as well and are theoretically supported by the disclosed techniques, and their implementation can be vendor-specific.

Referring to FIG. 1, even though search space 102 is illustrated as 2D, the disclosure is not limited in this regard, and search space 102 can be N-dimensional, where Nis an integer greater than 2. For example, the search space 102 can be based on more than 2 EQ parameters so that EQ tuning and calibration can be performed for multiple circuits (e.g., a transmitter circuit, a receiver circuit, a redriver circuit, etc.).

Referring again to FIG. 1, after search space 102 is configured/selected based on a range for each of the EQ parameters used for the search space, an initial sample 104 is selected from a plurality (or a set) of samples of the search space 102. Subsequently, one or more additional samples (e.g., samples 106, 108, 110, and 112) can be selected (e.g., based on a pre-configured distance and/or direction from the initial sample 104). The search space 102 can then be divided (or partitioned) into one or more partitions (e.g., partitions 114, 116, and 118), where at least one of the selected samples is located in each of the partitions. For example, sample 108 is in partition 114, samples 106, 104, and 112 are in partition 116, and sample 110 is in partition 118.

In some aspects, if more than one of the selected samples is located in a single partition, then such partition is further subdivided into smaller partitions. For example, partition 116 is subdivided into smaller partitions 120, 122, and 124 (including samples 106, 104, and 112, respectively). In some aspects, every time sampling a new point is performed, a new partition is created. However, based on the disclosed techniques, the initialization process (e.g., as shown in FIG. 1) is based on sampling all the points first and then deciding on the partitions later.

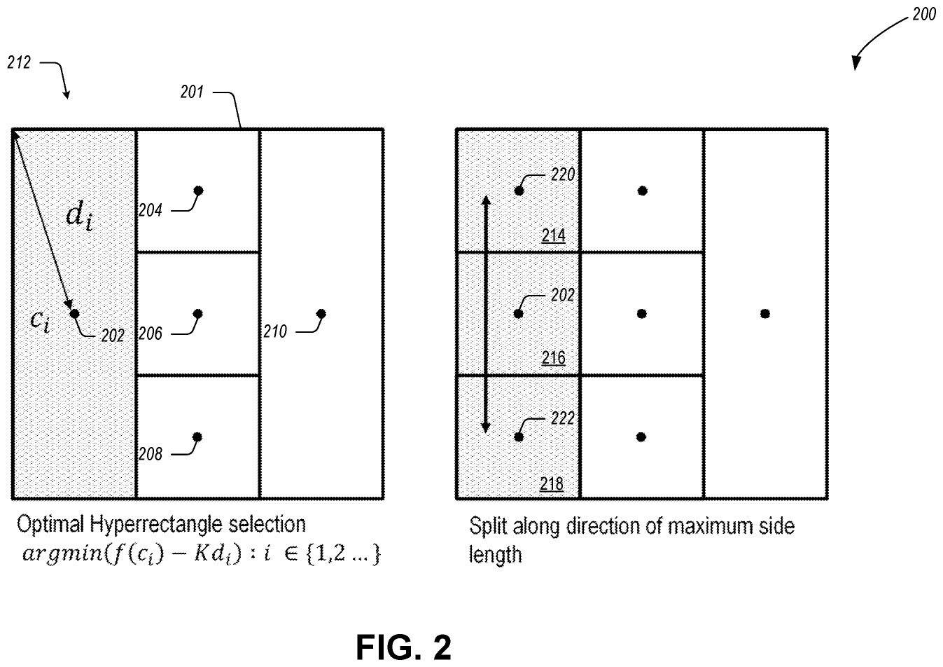

FIG. 2 illustrates diagram 200 of the splitting of a search space from a previously optimal result, in accordance with some embodiments.

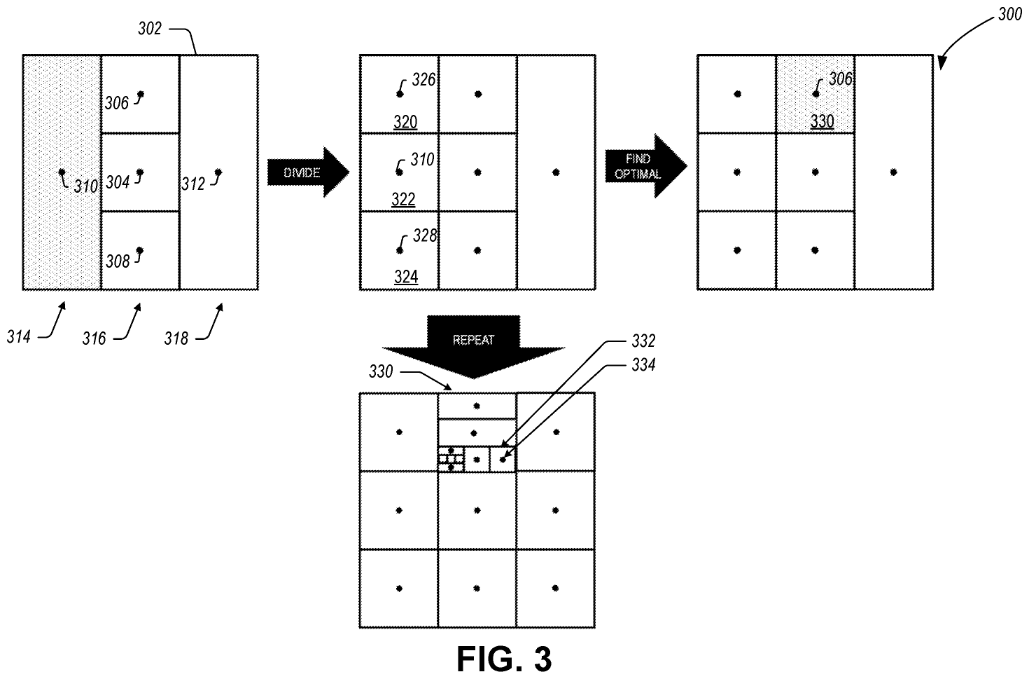

FIG. 3 illustrates a diagram 300 of successive partitions of the search space until a global minimum is found, in accordance with some embodiments.

FIGS. 2-3 illustrate an example of optimizing two EQ parameters where the search space is successively split into more precise bounds. The disclosed partitioning scheme can be used in connection with discrete EQ values. The relative simplicity of the calculations means minimal additional complexity to PHY design.

Referring to FIG. 2, a search space 201 is configured and one or more initial samples can be selected (e.g., samples 202, 204, 206, 208, and 210). After the initial one or more samples are selected, an evaluation is performed of a signal quality characteristic (e.g., BER) associated with each of the samples. The most optimal sample is then selected (e.g., sample 202), which results in the most optimal signal quality characteristic (e.g., a minimal BER). The search space is partitioned so that each of the initial samples is in a separate partition. For example, sample 202 is in partition 212. As used herein, the term “optimal” includes both the optimal signal quality characteristic and some scaled diagonal length for the encompassing (hyper) rectangle.

After the most optimal sample is selected (e.g., sample 202), additional samples (e.g., samples 220 and 222) are selected from the same partition (e.g., partition 212). Partition 212 is then subdivided into smaller partitions 214, 216, and 218, where each of the smaller partitions includes a separate sample.

In some aspects, all available samples in search space 201 can be re-evaluated for the most optimal signal quality characteristic (e.g., which sample produces a low BER and has a large remaining search space), and a new most optimal sample is selected. The partition of the most optimal sample is further subdivided so that a set of successively smaller partitions is obtained and a new sample is selected in each resulting new partition. A new iteration of sample evaluation for the entire search space is performed and the cycle repeats a pre-configured number of times (e.g., until a pre-configured number of successively smaller partitions of the initial search space is obtained). At the end, the EQ parameters associated with the most optimal sample (e.g., the sample whose EQ parameters generate the most optimal signal quality characteristic, such as the lowest BER) are then selected for signal EQ.

Referring to FIG. 3, diagram 300 is another example of determining optimal EQ parameters using search space partitioning. For example, a search space 302 is configured and one or more initial samples can be selected (e.g., samples 304, 306, 308, 310, and 312). After the initial one or more samples are selected, an evaluation is performed of a signal quality characteristic (e.g., BER) associated with each of the samples. The most optimal sample is then selected (e.g., sample 310), which results in the most optimal signal quality characteristic (e.g., a minimal BER). The search space 302 is partitioned so that each of the initial samples is in a separate partition. For example, sample 310 is in partition 314, samples 304-308 are in partition 316, and sample 312 is in partition 318.

After the most optimal sample is selected (e.g., sample 310), additional samples (e.g., samples 326 and 328) are selected from the same partition (e.g., partition 314). Partition 314 is then subdivided into smaller partitions 320, 322, and 324, where each of the smaller partitions includes a separate sample (e.g., samples 326, 310, and 328).

All available samples in search space 302 can be re-evaluated for the most optimal signal quality characteristic (e.g., which sample produces the minimal BER), and a new most optimal sample (e.g., sample 306) in partition 330 is selected. The evaluation and partitioning process can be repeated for a pre-configured number of times until a final optimal sample is obtained, and final EQ parameters are determined based on such sample. For example, after numerous sample selections and search space partitioning into successively smaller partitions (e.g., partition 330 is partitioned into successively smaller partitions as the most optimal sample is located in such partition after each iteration), a final partition 332 (within partition 330) is selected with sample 334 being the final optimal sample. The EQ parameter output is then determined based on sample 334.

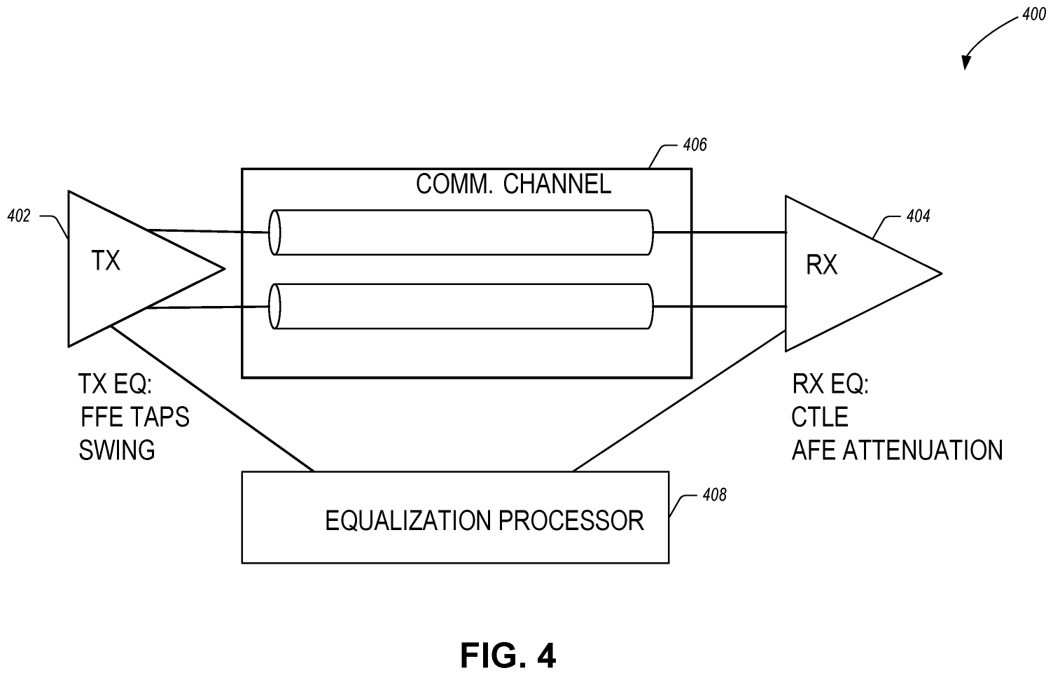

To benchmark the performance of the disclosed EQ techniques on a real device, a pulse amplitude modulation with 4 levels (PAM4) interconnect channel of variable loss can be set up as illustrated in FIG. 4.

FIG. 4 is a block diagram of a communication system 400 using an equalization processor to perform equalization based on the disclosed techniques, in accordance with some embodiments. Referring to FIG. 4, communication system 400 includes a Tx circuit 402, an Rx circuit 404, a communication channel 406 (e.g., a PAM4-based interconnect channel) between the Tx circuit 402 and the Rx circuit 404, and an equalization processor 408. The equalization processor 408 is configured to implement the disclosed EQ techniques for determining EQ parameters for equalizing components of the communication system 400 (e.g., performing signal equalization of the Tx circuit 402 and the Rx circuit 404).

Even though the equalization processor 408 is illustrated in FIG. 4 as a separate component/circuit, the disclosure is not limited in this regard and the equalization processor 408 can be an integrated component/circuit (e.g., integrated as part of the Tx circuit 402, the Rx circuit 404, or a transceiver circuit that combines a Tx circuit and an Rx circuit which can also communicate with each other, such as for link training or other purposes).

The equalization processor 408 can apply the disclosed EQ techniques to optimize both Tx and Rx circuitry of the PHY simultaneously, tuning six combined EQ parameters, such as Tx pre-tap, Tx main tap, Tx post-tap, Tx swing, Rx CTLE, and Rx AFE attenuation. Each of these parameters is discrete with different step sizes.

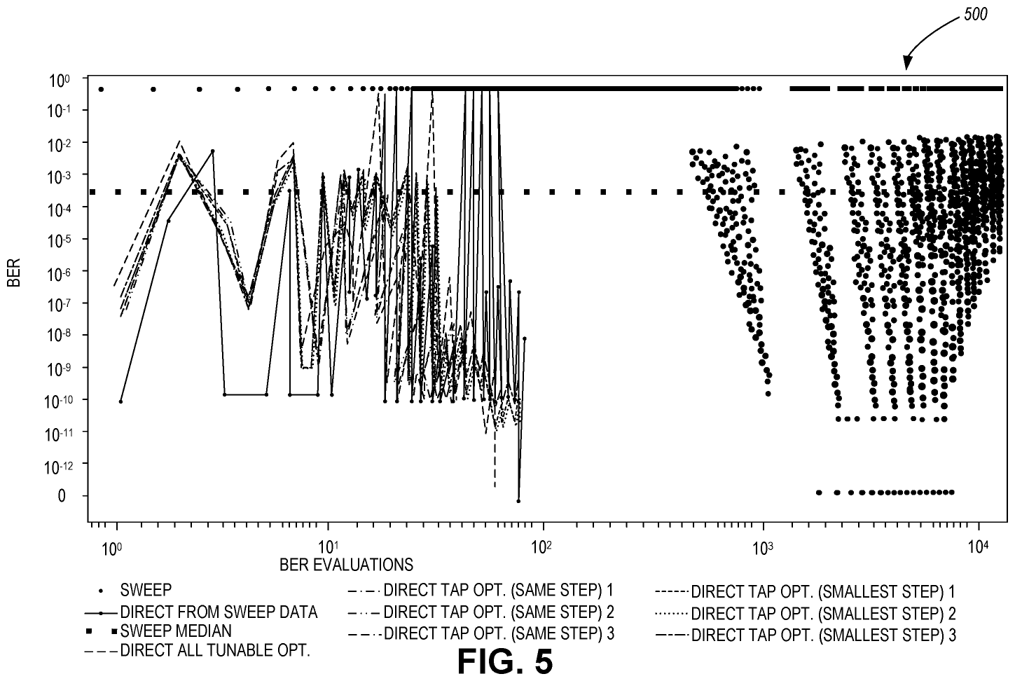

FIG. 5 is a combination graph 500 showing a comparison between equalization tuning using the disclosed techniques and equalization tuning based on coarse transmitted taps sweeps on a 28 dB (insertion loss (IL) at 13.28 GHz) channel at 53 GBit/s data communication, in accordance with some embodiments.

Referring to FIG. 5, optimizations 1, 2, and 3 refer to re-runs of the disclosed EQ techniques (e.g., the techniques discussed in connection with FIGS. 1-3) to illustrate that the disclosed EQ techniques are consistent across multiple iterations. Additional BER data is provided in Table 1 below.

TABLE 1

| | | Best bit | |
|---|---|---|---|
| | # possible | error rate | # |
| | combinations | (BER) | Evaluations |
| Coarse tap sweep | 9261 | <1E−12 | 9261 |
| DIRECT tap opt. | 9261 | 6.27E−11 | 26 |
| (same step) #1 | | | |
| DIRECT tap opt. | 9261 | 1.25E−11 | 26 |
| (same step) #2 | | | |
| DIRECT tap opt. | 9261 | 5.01E−11 | 26 |
| (same step) #3 | | | |
| DIRECT tap opt. | 6.4E8 | 1.25E−11 | 46 |
| (smallest step) #1 | | | |
| DIRECT tap opt. | 6.4E8 | 1.25E−11 | 59 |
| (smallest step) #2 | | | |
| DIRECT tap opt. | 6.4E8 | 1.00E−10 | 46 |
| (smallest step) #3 | | | |
| DIRECT All | 8.6016E11 | <1E−12 | 46 |

FIG. 5 further illustrates a comparison of BER over function evaluations during tuning. The sweep coarsely steps the Tx pre, Tx main, and Tx post-FFE taps of an end-to-end 28 dB (insertion loss (IL) at 13.28 GHZ) channel at 53 Gbit/s.

As illustrated in FIG. 5, the disclosed techniques terminate almost three orders of magnitude faster, with only 26 evaluations versus 9261 when using the coarse tap sweep for determining EQ parameters. The disclosed EQ techniques can be used to tune transmitted taps, voltage swing, CTLE, and received AFE attenuation simultaneously. This tuning can take a similar number of steps to converge, even when increasing granularity, and can yield optimal results.

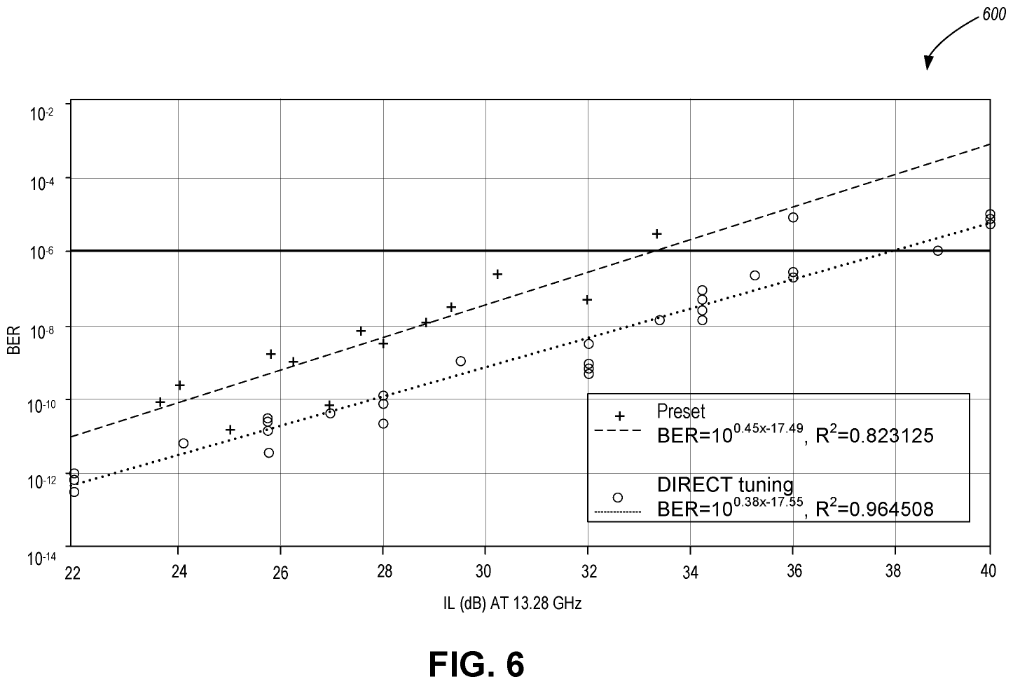

FIG. 6 is a combination graph 600 of a comparison between using a recommended preset versus using the disclosed equalization techniques for each channel, in accordance with some embodiments.

To evaluate the ability of the disclosed EQ techniques to optimize a variety of channels, channel performance can be collected across a range of channel insertion losses (IL) ranging from 22 to 40 dB at 13.28 GHz. FIG. 6 compares an initial tuning center around the 32 dB channel with the EQ parameter tunning of all EQ parameters for each channel using the disclosed techniques. As illustrated in FIG. 6, the algorithm performed better than the recommended settings. For all measured cases in FIG. 6, the algorithm achieved comparable or better performance than the presets.

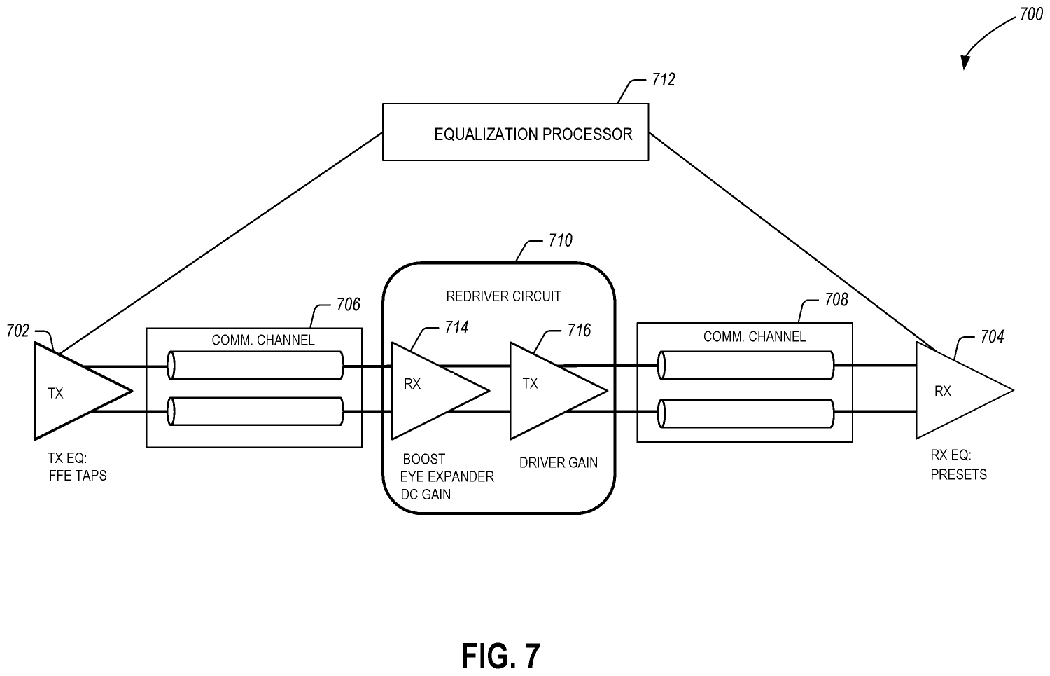

FIG. 7 is a block diagram of a communication system 700 using an equalization processor and a redriver to perform equalization based on the disclosed techniques, in accordance with some embodiments.

By treating the BER as a “black box,” the disclosed EQ techniques can be used to tune without requiring detailed knowledge about the waveform at different points within the channel. This particularly benefits tuning unknown EQ parameters, such as when dealing with EQ presets on external intellectual properties (IPs). Furthermore, some topologies cannot be tuned individually without altering the channel.

Referring to FIG. 7, communication system 700 includes a Tx circuit 702, an Rx circuit 704, a redriver circuit 710, a communication channel 706 between the Tx circuit 702 and the redriver circuit 710, a communication channel 708 between the redriver circuit 710 and the Rx circuit 704, and an equalization processor 712. The redriver circuit includes an Rx circuit 714 and a Tx circuit 716. The equalization processor 712 is configured to implement the disclosed EQ techniques for determining EQ parameters for equalizing components of the communication system 700 (e.g., performing signal equalization of the Tx circuit 702, the Tx circuit 716, the Rx circuit 704, and the Rx circuit 714).

Even though the equalization processor 712 is illustrated in FIG. 7 as a separate component/circuit, the disclosure is not limited in this regard and the equalization processor 712 can be an integrated component/circuit (e.g., integrated as part of the Tx circuit 702, the Rx circuit 704, the redriver circuit 710, or a transceiver circuit that combines a Tx circuit and an Rx circuit of the communication system 700).

The equalization processor 712 can apply the disclosed EQ techniques to optimize both Tx and Rx circuitry of the PHY simultaneously, tuning, e.g., six combined EQ parameters, such as Tx pre-tap, Tx main tap, Tx post-tap, Tx swing, Rx CTLE, and Rx AFE attenuation. Each of these parameters is discrete with different step sizes.

FIG. 7 illustrates a redriver circuit that has both a Tx circuit 716 and an Rx circuit 714 on a monolithic die, which makes probing the received signal difficult. Traditional methods of determining equalization parameters that depend on measuring the waveform to correct distortions, such as zero-forcing or minimum mean-square error equalizers, cannot be easily applied. This is further complicated by the fact that “equalizations” at the start of the channel will be distorted as they travel and then amplified by later equalization stages. However, the disclosed EQ techniques can be applied to components of the communication system 700, including the redriver circuit 710.

The configuration of FIG. 7 includes two sets of tunable transmitters and receivers due to the redriver circuit within the channel. In some aspects, algorithmically, no distinctions can be drawn between the EQ parameters of the redriver circuit and the original transmitter (e.g., Tx circuit 702) as both devices can be tuned simultaneously using the disclosed EQ techniques. The disclosed EQ techniques can handle an arbitrary number of intermediary stages (e.g., N number of redrivers or retimers within the communication channel). In some aspects, different EQ parameters used for different components of the communication system 700 can be used for configuring the search space and applying the disclosed EQ techniques.

Unlike commonly available EQ parameters, the settings of the redriver circuit 710 can be obfuscated (e.g., boost, eye expander, DC gain, and driver gain levels) with only a few discrete steps and with no direct mapping to the physical effects within the waveform.

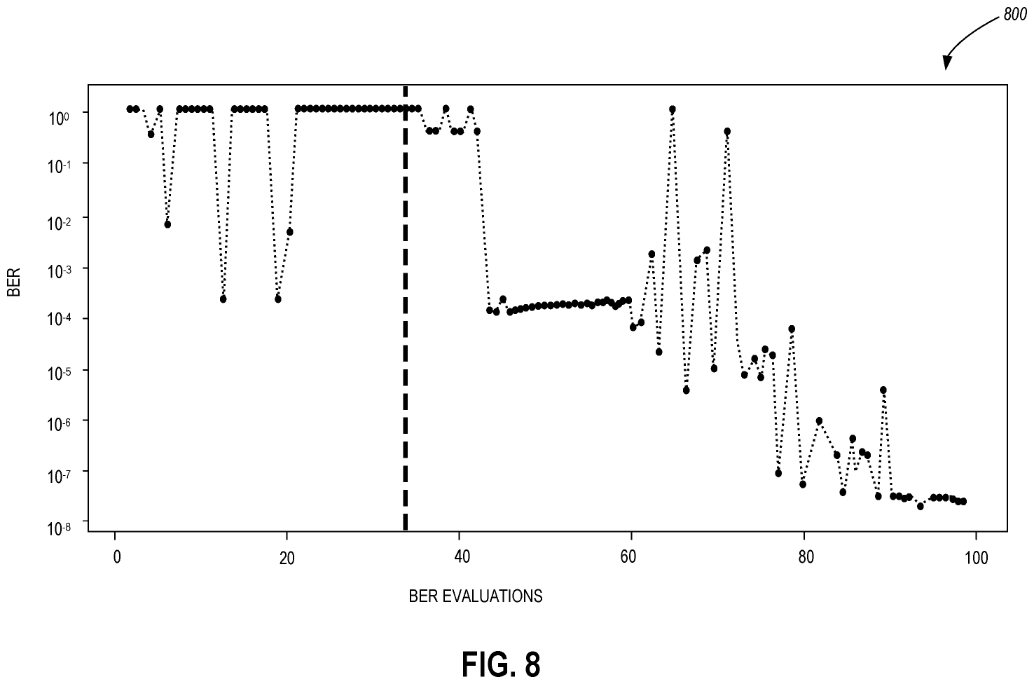

FIG. 8 is a graph 800 of bit error rate (BER)-based equalization using the disclosed techniques during tuning of 30 dB (IL at 13.28 GHZ) channel with a redriver, in accordance with some embodiments.

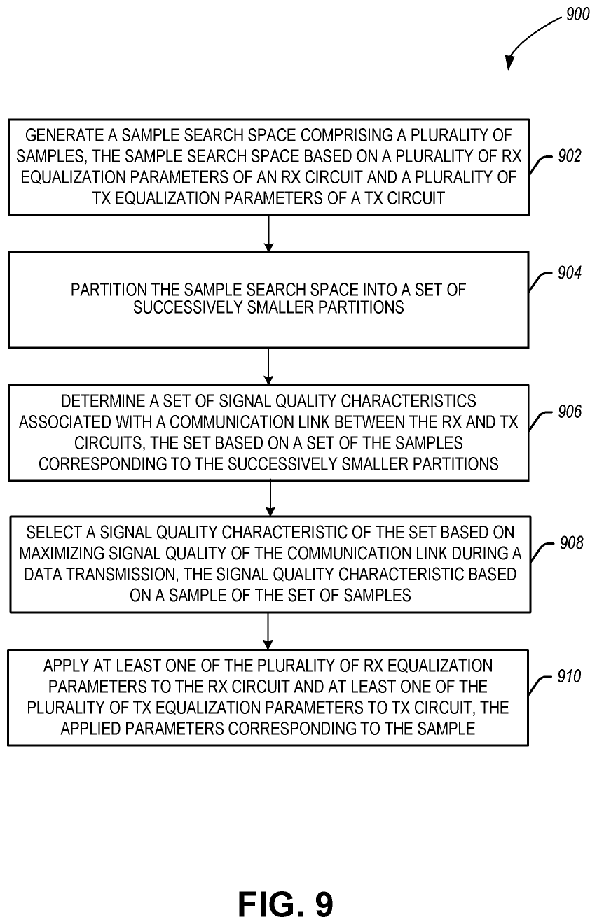

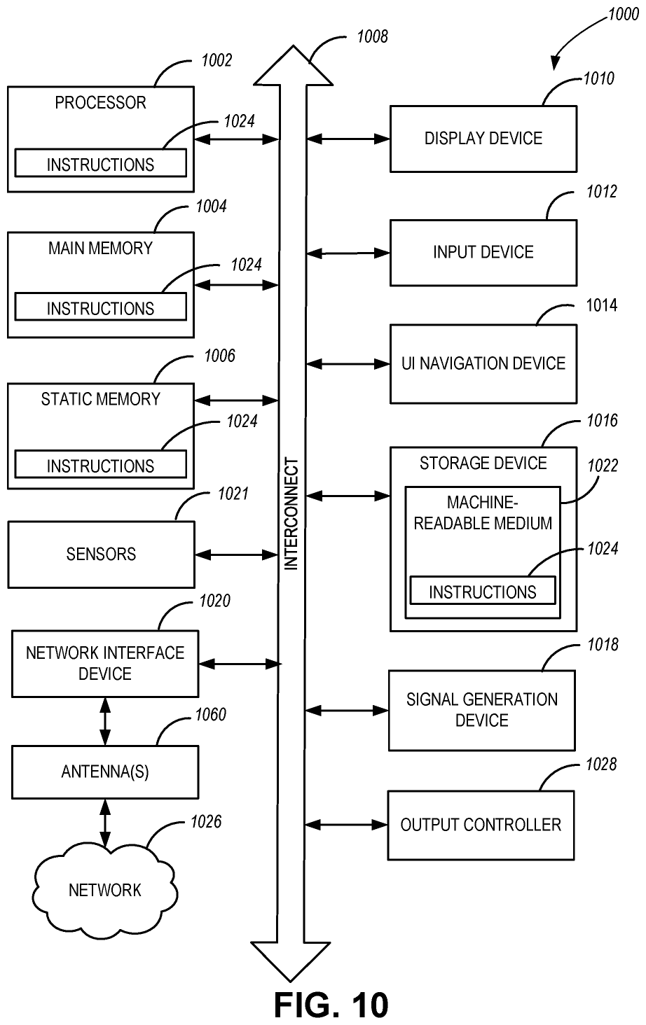

FIG. 9 is a flow diagram of an example method 900 for signal equalization, in accordance with some embodiments. Referring to FIG. 9, method 900 includes operations 902, 904, 906, 908, and 910, which may be executed by an equalization processor, equalization circuitry, or another processor of a computing device (e.g., hardware processor 1002 of machine 1000 illustrated in FIG. 10). In some embodiments, equalization processor 408 or equalization processor 712 can perform the signal equalization functionalities discussed herein as well as in the examples listed below.

At operation 902, a sample search space comprising a plurality of samples is generated. The sample search space (e.g., search space 302) is based on a plurality of Rx equalization parameters associated with an Rx circuit (e.g., Rx circuit 404) and a plurality of Tx equalization parameters associated with a Tx circuit (e.g., Tx circuit 402).

At operation 904, the sample search space is partitioned into a set of successively smaller partitions. For example, search space 302 is partitioned based on the techniques discussed in connection with FIG. 1-FIG. 3.

At operation 906, a set of signal quality characteristics associated with a communication link between the Rx circuit and the Tx circuit is determined. The set of signal quality characteristics is based on a set of samples of the plurality of samples corresponding to the set of successively smaller partitions. For example, the set of signal quality characteristics can be a set of BER values determined for the set of samples 304-312.

At operation 908, a signal quality characteristic of the set of signal quality characteristics is selected based on maximizing the signal quality of the communication link during data transmission between the Tx circuit and the Rx circuit. The signal quality characteristic of the set is based on a sample of the set of samples. For example, and as discussed in connection with FIG. 3, additional partitioning and iterations can be performed for a pre-configured number of times until a final desired sample (e.g., sample 334 in the final partition 332) is determined based on optimizing the signal quality characteristic (e.g., minimizing the BER value).

At operation 910, an Rx equalization parameter of the plurality of Rx equalization parameters is applied to the Rx circuit, and a Tx equalization parameter of the plurality of Tx equalization parameters is applied to the Tx circuit. The Rx equalization parameter and the Tx equalization parameter correspond to the sample. For example, the Rx and Tx equalization parameters (e.g., final CTLE and Tx main tap) are determined based on the final/optima sample (e.g., sample 334), and such EQ parameters are applied to the corresponding Rx and Tx circuits to complete the signal EQ optimization.

FIG. 10 illustrates a block diagram of an example machine 1000 upon which any one or more of the techniques (e.g., methodologies) discussed herein may perform. In alternative embodiments, the machine 1000 may operate as a standalone device or may be connected (e.g., networked) to other machines. In a networked deployment, machine 1000 may operate in the capacity of a server machine, a client machine, or both in server-client network environments. In an example, machine 1000 may function as a peer machine in a peer-to-peer (P2P) (or other distributed) network environment. The machine 1000 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

Machine (e.g., computer system) 1000 may include a hardware processor 1002 (e.g., a central processing unit (CPU), a graphics processing unit (GPU), a hardware processor core, or any combination thereof), a main memory 1004, and a static memory 1006, some or all of which may communicate with each other via an interlink (e.g., bus) 1008. In some aspects, the main memory 1004, the static memory 1006, or any other type of memory (including cache memory) used by the machine 1000 can be configured based on the disclosed techniques or can implement the disclosed memory devices.

Specific examples of main memory 1004 include Random Access Memory (RAM), and semiconductor memory devices, which may include, in some embodiments, storage locations in semiconductors such as registers. Specific examples of static memory 1006 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 1000 may further include a display device 1010, an input device 1012 (e.g., a keyboard), and a user interface (UI) navigation device 1014 (e.g., a mouse). In an example, the display device 1010, input device 1012, and UI navigation device 1014 may be a touch screen display. The machine 1000 may additionally include a storage device (e.g., drive unit or another mass storage device) 1016, a signal generation device 1018 (e.g., a speaker), a network interface device 1020, and one or more sensors 1021, such as a global positioning system (GPS) sensor, compass, accelerometer, or other sensors. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the hardware processor 1002 and/or instructions 1024 may comprise processing circuitry and/or transceiver circuitry.

The storage device 1016 may include a machine-readable medium 1022 on which is stored one or more sets of data structures or instructions 1024 (e.g., software) embodying or utilized by any one or more of the techniques or functions described herein. Instructions 1024 may also reside, completely or at least partially, within the main memory 1004, within static memory 1006, or the hardware processor 1002 during execution thereof by the machine 1000. In an example, one or any combination of the hardware processor 1002, the main memory 1004, the static memory 1006, or the storage device 1016 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 1022 is illustrated as a single medium, the term “machine-readable medium” may include a single medium or multiple media (e.g., a centralized or distributed database, and/or associated caches and servers) configured to store instructions 1024.

An apparatus of the machine 1000 may be one or more of a hardware processor 1002 (e.g., a central processing unit (CPU), a graphics processing unit (GPU), a hardware processor core, or any combination thereof), a main memory 1004 and a static memory 1006, one or more sensors 1021, a network interface device 1020, one or more antennas 1060, a display device 1010, an input device 1012, a UI navigation device 1014, a storage device 1016, instructions 1024, a signal generation device 1018, and an output controller 1028. The apparatus may be configured to perform one or more of the methods and/or operations disclosed herein. The apparatus may be intended as a component of machine 1000 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 1000 and that causes machine 1000 to perform any one or more of the techniques of the present disclosure, or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 1024 may further be transmitted or received over a communications network 1026 using a transmission medium via the network interface device 1020 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1020 may include one or more physical jacks (e.g., Ethernet, coaxial, or phone jacks) or one or more antennas to connect to the communications network 1026. In an example, the network interface device 1020 may include one or more antennas 1060 to wirelessly communicate using at least one single-input multiple-output (SIMO), multiple-input multiple-output (MIMO), or multiple-input single-output (MISO) techniques. In some examples, the network interface device 1020 may wirelessly communicate using Multiple User MIMO techniques. The term “transmission medium” shall be taken to include any intangible medium that can store, encode, or carry instructions for execution by the machine 1000, and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments such as part of a system on chip, a set of intercommunicating functional blocks, or similar, although the scope of the disclosure is not limited in this respect.

Described implementations of the subject matter can include one or more features, alone or in combination as illustrated below by way of examples.

Example 1 is a system comprising: memory; and at least one processor coupled to the memory, the at least one processor to: generate a sample search space comprising a plurality of samples, the sample search space based on a plurality of receiver (Rx) equalization parameters associated with an Rx circuit and a plurality of transmitter (Tx) equalization parameters associated with a Tx circuit; partition the sample search space into a set of successively smaller partitions; determine a set of signal quality characteristics associated with a communication link between the Rx circuit and the Tx circuit, the set of signal quality characteristics based on a set of samples of the plurality of samples corresponding to the set of successively smaller partitions; select a signal quality characteristic of the set of signal quality characteristics based on maximizing signal quality of the communication link during a data transmission between the Tx circuit and the Rx circuit, the signal quality characteristic of the set based on a sample of the set of samples; and apply an Rx equalization parameter of the plurality of Rx equalization parameters to the Rx circuit and a Tx equalization parameter of the plurality of Tx equalization parameters to Tx circuit, the Rx equalization parameter and the Tx equalization parameter corresponding to the sample.

In Example 2, the subject matter of Example 1 includes, wherein the at least one processor is further to: select an initial sample of the plurality of samples based on a pre-defined location within the sample search space.

In Example 3, the subject matter of Example 2 includes, wherein the at least one processor is further to: select an initial set of samples of the plurality of samples, the initial set of samples including the initial sample and at least one additional sample, and the initial set of samples corresponding to an initial set of partitions of the sample search space.

In Example 4, the subject matter of any of Examples 1-3 includes, wherein the at least one processor is further to: determine a subset of the set of signal quality characteristics, the subset associated with the initial set of samples.

In Example 5, the subject matter of Example 4 includes, wherein the at least one processor is further to: select a signal quality characteristic of the subset based on maximizing the signal quality of the communication link during the data transmission between the Tx circuit and the Rx circuit, the signal quality characteristic of the subset based on a sample of the initial set of samples.

In Example 6, the subject matter of Example 5 includes, wherein the at least one processor is further to: perform successive partitions of a partition of the initial set of partitions associated with the sample of the initial set of samples, to generate the set of successively smaller partitions.

In Example 7, the subject matter of Example 6 includes, wherein the at least one processor is further to: perform the successive partitions for a pre-configured number of iterations.

In Example 8, the subject matter of Examples 1-7 includes, wherein the set of signal quality characteristics comprises one of bit error rate (BER) characteristics, eye height or width characteristics, and receiver margin characteristics. Some other examples include conformance to an ideal waveform (RMSE), signal-to-noise ratio (SNR), signal-to-distortion-and-noise ratio (SNDR), and jitter.

In Example 9, the subject matter of Examples 1-8 includes, wherein the at least one processor is further to generate the sample search space as a two-dimensional search space based on the plurality of Rx equalization parameters and the plurality of Tx equalization parameters.

In Example 10, the subject matter of Example 9 includes, wherein the plurality of Rx equalization parameters comprise one of continuous time linear equalization (CTLE) parameters; and analog front-end (AFE) attenuation parameters.

In Example 11, the subject matter of Example 10 includes, wherein the plurality of Tx equalization parameters comprise one of Tx pre-tap equalization parameters; Tx main tap equalization parameters; Tx post-tap equalization parameters; and Tx swing parameters.

In Example 12, the subject matter of Examples 1-11 includes, wherein the at least one processor is further to generate the sample search space as a multi-dimensional search space based on the plurality of Rx equalization parameters and the plurality of Tx equalization parameters, the multi-dimensional search space associated with a dimension greater than two.

In Example 13, the subject matter of Example 12 includes, wherein the plurality of Rx equalization parameters comprise at least continuous time linear equalization (CTLE) parameters and analog front-end (AFE) attenuation parameters.

In Example 14, the subject matter of Example 13 includes, wherein the plurality of Tx equalization parameters comprise at least two of Tx pre-tap equalization parameters; Tx main tap equalization parameters; Tx post-tap equalization parameters; and Tx swing parameters.

In Example 15, the subject matter of Examples 1-14 includes the Rx circuit; the Tx circuit; and an interface between the Rx circuit and the Tx circuit, the interface including the communication link.

In Example 16, the subject matter of Example 15 includes, wherein the interface is a wired interface.

In Example 17, the subject matter of Examples 15-16 includes, one or more interconnects coupling the at least one processor, the Tx circuit, and the Rx circuit.

In Example 18, the subject matter of Examples 1-17 includes, a redriver circuit coupled to the at least one processor, the redriver circuit comprising a second Rx circuit and a second Tx circuit.

In Example 19, the subject matter of Example 18 includes a first interface between the Tx circuit and the second Rx circuit of the redriver circuit; and a second interface between the second Tx circuit of the redriver circuit and the Rx circuit.

In Example 20, the subject matter of Example 19 includes, wherein the first interface and the second interface are wired interfaces.

In Example 21, the subject matter of Examples 18-20 includes, wherein the at least one processor is further to: apply the Rx equalization parameter of the plurality of Rx equalization parameters to the second Rx circuit of the redriver circuit; and apply the Tx equalization parameter of the plurality of Tx equalization parameters to second Tx circuit of the redriver circuit.

In Example 22, the subject matter of Examples 19-21 includes, wherein the sample search space is further based on a second plurality of Rx equalization parameters associated with the second Rx circuit and a second plurality of Tx equalization parameters associated with the second Tx circuit.

In Example 23, the subject matter of Example 22 includes, wherein the at least one processor is further to: determine a second set of signal quality characteristics associated with the first interface and the second interface, the second set of signal quality characteristics based on a second set of samples of the plurality of samples corresponding to the set of successively smaller partitions; select a second signal quality characteristic of the second set of signal quality characteristics based on maximizing signal quality of a second data transmission between the Tx circuit and the Rx circuit via the first interface and the second interface of the redriver circuit, the second signal quality characteristic of the second set based on a second sample of the second set of samples; and apply a second Rx equalization parameter of the plurality of Rx equalization parameters to the second Rx circuit and a second Tx equalization parameter of the plurality of Tx equalization parameters to second Tx circuit, the second Rx equalization parameter and the second Tx equalization parameter corresponding to the second sample.

Example 24 is a system comprising: a first transmit (Tx) circuit; a first receive (Rx) circuit; a redriver circuit, the redriver circuit comprising a second Rx circuit and a second Tx circuit, the second Rx circuit coupled to the first Tx circuit and the second Tx circuit coupled to the first Rx circuit; and an equalization circuit coupled to the first Tx circuit, the first Rx circuit, and the redriver circuit.

In Example 25, the subject matter of Example 24 includes, wherein the equalization circuit comprises at least one processor to generate a sample search space comprising a plurality of samples, the sample search space based on a plurality of Rx equalization parameters and a plurality of Tx equalization parameters; partition the sample search space into a set of successively smaller partitions; and generate a set of equalization parameters for the first Tx circuit, the first Rx circuit, the second Tx circuit, and the second Rx circuit based on the set of successively smaller partitions.

In Example 26, the subject matter of Example 25 includes, wherein the at least one processor is further to: determine a set of signal quality characteristics associated with a communication link between the first Tx circuit, the redriver circuit, and the first Rx circuit, the set of signal quality characteristics based on a set of samples of the plurality of samples corresponding to the set of successively smaller partitions; select a signal quality characteristic of the set of signal quality characteristics based on maximizing signal quality of the communication link during a data transmission between the first Tx circuit, the redriver circuit, and the first Rx circuit, the signal quality characteristic of the set based on a sample of the set of samples; and apply at least one Rx equalization parameter of the set of equalization parameters to the first Rx circuit and the second Rx circuit, and at least one Tx equalization parameter of the set of equalization parameters to first Tx circuit and the second Tx circuit, the set of equalization parameters corresponding to the sample.

In Example 27, the subject matter of Example 26 includes, wherein the at least one processor is further to: select an initial sample of the plurality of samples based on a pre-defined location within the sample search space.

In Example 28, the subject matter of Example 27 includes, wherein the at least one processor is further to: select an initial set of samples of the plurality of samples, the initial set of samples including the initial sample and at least one additional sample, and the initial set of samples corresponding to an initial set of partitions of the sample search space.

In Example 29, the subject matter of Example 28 includes, wherein the at least one processor is further to: determine a subset of the set of signal quality characteristics, the subset associated with the initial set of samples.

In Example 30, the subject matter of Example 29 includes, wherein the at least one processor is further to: select a signal quality characteristic of the subset based on maximizing the signal quality of the communication link during the data transmission between the Tx circuit and the Rx circuit, the signal quality characteristic of the subset based on a sample of the initial set of samples.

In Example 31, the subject matter of Example 30 includes, wherein the at least one processor is further to: perform successive partitions of a partition of the initial set of partitions associated with the sample of the initial set of samples, to generate the set of successively smaller partitions.

In Example 32, the subject matter of Example 31 includes, wherein the at least one processor is further to: perform the successive partitions for a pre-configured number of iterations.

In Example 33, the subject matter of Examples 26-32 includes, wherein the set of signal quality characteristics comprises one of bit error rate (BER) characteristics, eye height or width characteristics, and receiver margin characteristics.

Example 34 is a method comprising: generating a sample search space comprising a plurality of samples, the sample search space based on a plurality of receiver (Rx) equalization parameters associated with an Rx circuit and a plurality of transmitter (Tx) equalization parameters associated with a Tx circuit; partitioning the sample search space into a set of successively smaller partitions; determining a set of signal quality characteristics associated with a communication link between the Rx circuit and the Tx circuit, the set of signal quality characteristics based on a set of samples of the plurality of samples corresponding to the set of successively smaller partitions; selecting a signal quality characteristic of the set of signal quality characteristics based on maximizing signal quality of the communication link during a data transmission between the Tx circuit and the Rx circuit, the signal quality characteristic of the set based on a sample of the set of samples; and applying an Rx equalization parameter of the plurality of Rx equalization parameters to the Rx circuit and a Tx equalization parameter of the plurality of Tx equalization parameters to Tx circuit, the Rx equalization parameter and the Tx equalization parameter corresponding to the sample.

In Example 35, the subject matter of Example 34 includes, selecting an initial sample of the plurality of samples based on a pre-defined location within the sample search space.

In Example 36, the subject matter of Example 35 includes, selecting an initial set of samples of the plurality of samples, the initial set of samples including the initial sample and at least one additional sample, and the initial set of samples corresponding to an initial set of partitions of the sample search space.

In Example 37, the subject matter of Example 36 includes, determining a subset of the set of signal quality characteristics, the subset associated with the initial set of samples.

In Example 38, the subject matter of Example 37 includes, selecting a signal quality characteristic of the subset based on maximizing the signal quality of the communication link during the data transmission between the Tx circuit and the Rx circuit, the signal quality characteristic of the subset based on a sample of the initial set of samples.

In Example 39, the subject matter of Example 38 includes, performing successive partitions of a partition of the initial set of partitions associated with the sample of the initial set of samples, to generate the set of successively smaller partitions.

In Example 40, the subject matter of Example 39 includes, performing the successive partitions for a pre-configured number of iterations.

Example 41 is an apparatus comprising means to perform a method as stated in any of the preceding Examples 34-40.

Example 42 is machine-readable storage including machine-readable instructions, when executed, cause a transceiver to implement a method as stated in any of the preceding Examples 34-40.

Example 43 is machine-readable storage including machine-readable instructions, when executed, cause an equalization circuit to implement a method as stated in any of the preceding Examples 34-40.

Example 44 is a computer program comprising instructions which, when the program is executed by a computer, cause the computer to carry out the method as stated in any of the preceding Examples 34-40.

Example 45 is at least one machine-readable medium including instructions that, when executed by processing circuitry, cause the processing circuitry to perform operations to implement any of the preceding Examples 1-44.

Example 46 is an apparatus comprising means to implement any of Examples 1-44.

Example 47 is a system to implement any of Examples 1-44.

Example 48 is a method to implement any of Examples 1-44.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

What is claimed is:

1. A system comprising:
memory; and
at least one processor coupled to the memory, the at least one processor to:
generate a sample search space comprising a plurality of samples, the sample search space based on a plurality of receiver (Rx) equalization parameters associated with an Rx circuit and a plurality of transmitter (Tx) equalization parameters associated with a Tx circuit;
partition the sample search space into a set of successively smaller partitions;
determine a set of signal quality characteristics associated with a communication link between the Rx circuit and the Tx circuit, the set of signal quality characteristics based on a set of samples of the plurality of samples corresponding to the set of successively smaller partitions;
select a signal quality characteristic of the set of signal quality characteristics based on maximizing signal quality of the communication link during data transmission between the Tx circuit and the Rx circuit, the signal quality characteristic of the set based on a sample of the set of samples; and
apply an Rx equalization parameter of the plurality of Rx equalization parameters to the Rx circuit and a Tx equalization parameter of the plurality of Tx equalization parameters to the Tx circuit, the Rx equalization parameter and the Tx equalization parameter corresponding to the sample.

2. The system of claim 1, wherein the at least one processor is further to:
select an initial sample of the plurality of samples based on a pre-defined location within the sample search space.

3. The system of claim 2, wherein the at least one processor is further to:
select an initial set of samples of the plurality of samples, the initial set of samples including the initial sample and at least one additional sample, and the initial set of samples corresponding to an initial set of partitions of the sample search space.

4. The system of claim 3, wherein the at least one processor is further to:
determine a subset of the set of signal quality characteristics, the subset associated with the initial set of samples.

5. The system of claim 4, wherein the at least one processor is further to:
select a signal quality characteristic of the subset based on maximizing the signal quality of the communication link during the data transmission between the Tx circuit and the Rx circuit, the signal quality characteristic of the subset based on a sample of the initial set of samples.

6. The system of claim 5, wherein the at least one processor is further to:
perform successive partitions of a partition of the initial set of partitions associated with the sample of the initial set of samples, to generate the set of successively smaller partitions.

7. The system of claim 6, wherein the at least one processor is further to:
perform the successive partitions for a pre-configured number of iterations.

8. The system of claim 1, wherein the set of signal quality characteristics comprises one of bit error rate (BER) characteristics, eye height or width characteristics, and receiver margin characteristics.

9. The system of claim 1, wherein the at least one processor is further to:
generate the sample search space as a two-dimensional search space based on the plurality of Rx equalization parameters and the plurality of Tx equalization parameters.

10. The system of claim 9, wherein the plurality of Rx equalization parameters comprises one of:
continuous-time linear equalization (CTLE) parameters; and
analog front-end (AFE) attenuation parameters.

11. The system of claim 10, wherein the plurality of Tx equalization parameters comprises one of:
Tx pre-tap equalization parameters;
Tx main tap equalization parameters;
Tx post-tap equalization parameters; and
Tx swing parameters.

12. A system comprising:
a first transmit (Tx) circuit;
a first receive (Rx) circuit;
a redriver circuit, the redriver circuit comprising a second Rx circuit and a second Tx circuit, the second Rx circuit coupled to the first Tx circuit and the second Tx circuit coupled to the first Rx circuit; and
an equalization circuit coupled to the first Tx circuit, the first Rx circuit, and the redriver circuit.

13. The system of claim 12, wherein the equalization circuit comprises at least one processor to:
generate a sample search space comprising a plurality of samples, the sample search space based on a plurality of Rx equalization parameters and a plurality of Tx equalization parameters;
partition the sample search space into a set of successively smaller partitions; and
generate a set of equalization parameters for the first Tx circuit, the first Rx circuit, the second Tx circuit, and the second Rx circuit based on the set of successively smaller partitions.

14. The system of claim 13, wherein the at least one processor is further to:
determine a set of signal quality characteristics associated with a communication link between the first Tx circuit, the redriver circuit, and the first Rx circuit, the set of signal quality characteristics based on a set of samples of the plurality of samples corresponding to the set of successively smaller partitions;
select a signal quality characteristic of the set of signal quality characteristics based on maximizing signal quality of the communication link during data transmission between the first Tx circuit, the redriver circuit, and the first Rx circuit, the signal quality characteristic of the set based on a sample of the set of samples; and
apply at least one Rx equalization parameter of the set of equalization parameters to the first Rx circuit and the second Rx circuit, and at least one Tx equalization parameter of the set of equalization parameters to the first Tx circuit and the second Tx circuit, the set of equalization parameters corresponding to the sample.

15. The system of claim 14, wherein the at least one processor is further to:
select an initial sample of the plurality of samples based on a pre-defined location within the sample search space.

16. The system of claim 15, wherein the at least one processor is further to:
select an initial set of samples of the plurality of samples, the initial set of samples including the initial sample and at least one additional sample, and the initial set of samples corresponding to an initial set of partitions of the sample search space.

17. The system of claim 16, wherein the at least one processor is further to:
determine a subset of the set of signal quality characteristics, the subset associated with the initial set of samples.

18. A method comprising:
generating a sample search space comprising a plurality of samples, the sample search space based on a plurality of receiver (Rx) equalization parameters associated with an Rx circuit and a plurality of transmitter (Tx) equalization parameters associated with a Tx circuit;
partitioning the sample search space into a set of successively smaller partitions;
determining a set of signal quality characteristics associated with a communication link between the Rx circuit and the Tx circuit, the set of signal quality characteristics based on a set of samples of the plurality of samples corresponding to the set of successively smaller partitions;
selecting a signal quality characteristic of the set of signal quality characteristics based on maximizing signal quality of the communication link during data transmission between the Tx circuit and the Rx circuit, the signal quality characteristic of the set based on a sample of the set of samples; and
applying an Rx equalization parameter of the plurality of Rx equalization parameters to the Rx circuit and a Tx equalization parameter of the plurality of Tx equalization parameters to the Tx circuit, the Rx equalization parameter and the Tx equalization parameter corresponding to the sample.

19. The method of claim 18, further comprising:
selecting an initial sample of the plurality of samples based on a pre-defined location within the sample search space.

20. The method of claim 19, further comprising:
selecting an initial set of samples of the plurality of samples, the initial set of samples including the initial sample and at least one additional sample, and the initial set of samples corresponding to an initial set of partitions of the sample search space.
